(19) United States
(12) Patent Application Publication
(10) Pub. No.: US 2024/0221065 A1
(43) Pub. Date: Jul. 4, 2024

(54) BIDDING PROPOSAL EDITING SYSTEM

(71) Applicant: Schlumberger Technology Corporation, Sugar Land, TX (US)

(72) Inventors: Tianjun Hou, Antony (FR); Liliana Hancu, Bucharest (RO); Sharez Bahrom, Kuala Lumpur (MY); Raman Anggorodi, Jakarta Selatan (ID)

(21) Appl. No.: 18/470,671

(22) Filed: Sep. 20, 2023

Related U.S. Application Data
(60) Provisional application No. 63/477,397, filed on Dec. 28, 2022.

(51) Int. Cl. G06Q 30/08

(52) U.S. Cl. CPC G06Q 30/08

(57) ABSTRACT

Systems and methods of the present disclosure provide a bidding proposal system for bidding proposal preparation. The bidding proposal system includes an artificial intelligence (AI)-assisted system, which generates a predicted bidding proposal based on a received request. In the system, a natural language processing technique is applied to automatically generate potential answers to the questions asked by the purchaser. The systems and methods described herein enable a computing system to understand natural language of a user by identifying the user intent and providing information to generate an answer based on the user intent.

### CROSS-REFERENCE TO RELATED APPLICATION

This application claims priority to and the benefit of U.S. Provisional Patent Application Ser. No. 63/477,397, entitled “BIDDING PROPOSAL EDITING SYSTEM,” filed Dec. 28, 2022, which is hereby incorporated by reference in its entirety for all purposes.

### FIELD OF THE INVENTION

The present disclosure relates to systems and methods for bidding proposal preparation.

### BACKGROUND INFORMATION

Tendering or bidding is a transactional model used by organizations, companies, government bodies and NGOs (Non-Government Organizations) to find suppliers and contractors for particular projects. A tendering process may involve elaborate paperwork and record keeping. For suppliers and contractors, providing a bidding proposal is a part of the tendering preparation process. Indeed, a well-written bidding proposal may help increase the bidding wining rate and thus gain more contracts.

With this in mind, it should be noted that bidding proposal preparation involves complicated tasks that include receiving support from experts in different areas, such as communicating with the tenders, answering questions asked by the purchasers, understanding the requirements of the purchasers, evaluating the competitors, tailoring the proposal, drafting the bidding proposal document, and the like. Further, the projects of the contracts may be conducted in various locations on the world, and different locations may employ different polices, restrictions, etc. for the projects. Moreover, different languages may be used by different parties involved in the bidding proposal preparation. As such, efficiently preparing consistent bids that address the concerns of various organizations can be difficult. Accordingly, it is desirable to have a system to provide improved process systems for preparing bidding proposals.

### SUMMARY

A summary of certain embodiments described herein is set forth below. It should be understood that these aspects are presented merely to provide the reader with a brief summary of these certain embodiments and that these aspects are not intended to limit the scope of this disclosure.

In one embodiment, a method includes receiving, via a processing system, an input indicative of a question associated with a bid proposal request. The method also includes determining, via the processing system, an intent associated with the question. The method also includes determining, via the processing system, one or more answers associated with the question based on a machine learning model and the intent, and the machine learning model is generated based on a plurality of datasets associated with one or more correlations between a plurality of questions and a plurality of answers, and each of the plurality of datasets comprises a triplet of data including a respective question, a respective answer, and a respective reference. The method also includes presenting, via the processing system, the one or more answers via a visualization component depicted in an electronic display communicatively coupled to the processing system. The method also includes receiving, via the processing system, one or more modifications to the one or more answers via the visualization component to generate one or more modified answers. The method also includes exporting, via the processing system, the one or more modified answers to one or more fields of the bidding proposal request.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a schematic view of a hydrocarbon site, in accordance with an aspect of the present disclosure;

FIG. 2 illustrates a block diagram of a bidding proposal system, in accordance with an aspect of the present disclosure;

FIG. 3 illustrates an embodiment of a visualization for the bidding proposal system, in accordance with an aspect of the present disclosure;

FIG. 4 illustrates another embodiment of a visualization for the bidding proposal system, in accordance with an aspect of the present disclosure;

FIG. 5 illustrates a process flow diagram of a method for generating a machine learning model, in accordance with an aspect of the present disclosure;

FIG. 6 illustrates a process flow diagram of a method for preparing bidding proposals, in accordance with an aspect of the present disclosure; and

FIG. 7 illustrates a block diagram showing an example computing device, in accordance with an aspect of the present disclosure.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When introducing elements of various embodiments of the present disclosure, the articles “a,” “an,” and “the” are intended to mean that there are one or more of the elements. The terms “comprising.” “including.” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention). Indeed, it will be appreciated that the data processing system described herein may be configured to perform any and all of the data processing functions described herein automatically.

In addition, as used herein, the term “substantially similar” may be used to describe values that are different by only a relatively small degree relative to each other. For example, two values that are substantially similar may be values that are within 10% of each other, within 5% of each other, within 3% of each other, within 2% of each other, within 1% of each other, or even within a smaller threshold range, such as within 0.5% of each other or within 0.1% of each other.

As discussed above, bidding proposal preparation may become a time-consuming effort that involves tailoring a proposal in accordance with the questions asked by the purchaser. To make a tender coordinator's work more efficient, the present embodiments described herein may include an artificial intelligence (AI)-assisted system, which generates a predicted bidding proposal based on a received request. In the system, a natural language processing technique may be applied to automatically generate potential answers to the questions asked by the purchaser. The systems and methods described herein enable a computing system to understand natural language of a user by identifying the user intent and providing information to generate an answer based on the user intent.

In one embodiment, a bidding proposal system may include a frontend system and a backend system. The backend system of the bidding proposal system may not directly interact with users. Instead, the backend system may include a database, a training component, a predicting component, and a retraining component. The database may include a collection of datasets of triplets (Q, A, R). Each of the triplets may include a question (Q), an answer (A) to the question (Q), and a reference (R) corresponding to the answer (A). The datasets of triplets may be collected from previous bidding proposals stored in a database or other suitable storage. The database may also include the triplets provided to the bidding proposal system by a user.

By way of operation, the backend system may employ a training component that may use a natural language processing (NLP) machine learning model to evaluate the dataset of triplets. In the natural language processing (NLP) machine learning model, each question (Q) is identified based on its intent. For example, many questions asked by the users may have a same intent and may then be represented with the same question (Q). In addition, a same question asked by the users may have various intents under various situations and/or for various users and be represented with various questions (Q). Moreover, the users may use the bidding proposal system from various global locations and may use various foreign languages. As such, using user intents to identify questions may enable the back end system to employ a uniform standard to evaluate various bid requests. Each question (Q) may have one or more answers (A) with respective relevance levels. The relevance level is directly proportional to the confidence level. The machine learning model may be trained to identify a pattern between questions and answers and build a text embedding space with the triplets (Q, A, R). That is, the relationships between each element of the triplets may be represented with valued vectors that correspond to the relationship or strength of relationship between each element. After the machine learning model is generated, the backend system may use the machine learning model to predict answers provided by user inputs. That is, after receiving a question, the backend system may prepare the question (e.g., the backend system may translate the question using a default language) and determine the intent of the question using an NLP machine learning model. The backend system may search for the relevant (Q, A, R) triplet in the text embedding space by comparing the intent of the received question with the questions in the text embedding space. The backend system may identify the predicted answer to the received question based on the (Q, A, R) triplet that has the shorter distance in the text embedding space between the (Q, A, R) triplet and the question asked.

With the foregoing in mind, in some embodiments, the backend system may also include a predicting component that may apply the trained NLP machine learning model to the new question and automatically generate one or more predicted relevant answers. When a new question is received by the backend system, the distance in the text embedding space between each (Q, A, R) triplet and the new question is calculated and the top relevant answers (e.g., top three), together with the corresponding references, may be sent to the frontend system as predicted answers.

The frontend system of the bidding proposal system may generate a visualization that includes various components, such as a question input component, a potential answer visualizing component, an answer editing component, a reference visualizing component, a reference editing component, an output component, and the like. The question input component may enable users to input questions manually or upload questions from a file (e.g., an excel file). The potential answer visualizing component may present a list of relevant answers or references identified by the backend system for each question. In some embodiments, the answers and/or references may be ordered by relevance level as defined by the backend system. In some embodiments, the answer and/or reference editing component may enable users to accept or reject the answers and/or references generated by the backend system, add additional text to the answers or references, or modify the predicted answers or references. The output component may allow users to download the edited answers in a predefined format (e.g., word file containing the questions, the corresponding answers, the references), such that they may be used for the bidding proposal.

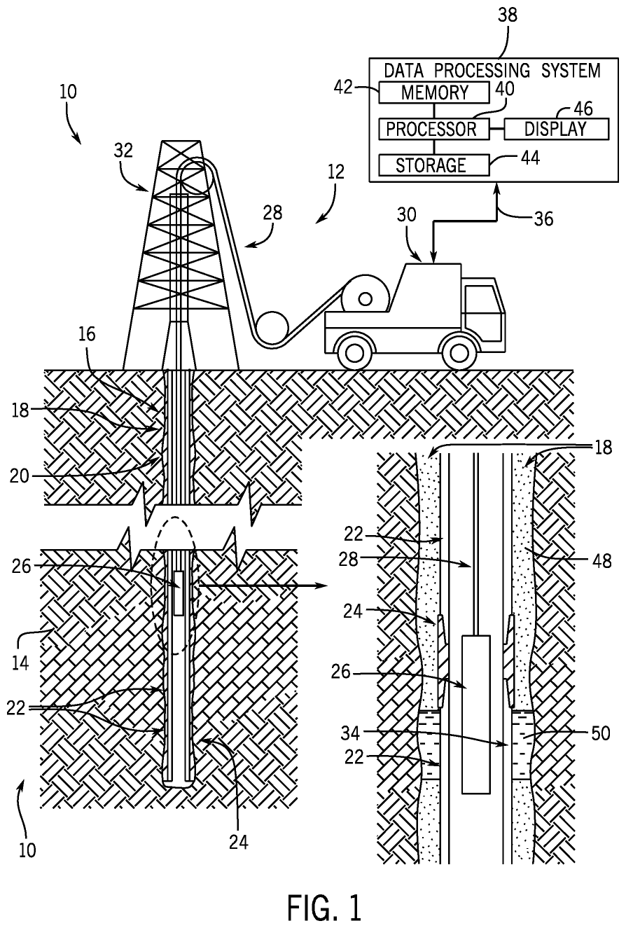

After users have edited a couple of bidding proposals with the bidding proposal system, the bidding proposal system may generate new (Q, A, R) triplets based on the couple of bidding proposals and store them into the database and update the text embedding space. These new (Q, A, R) triplets may be used to retrain the NLP machine learning model by using a retraining component. By retraining the machine learning model, the bidding proposal system may provide more accurate predictions for future questions. Additional details regarding the bidding proposal system will be illustrated in detail below with reference to FIGS. 1-7.

By way of introduction, FIG. 1 depicts a schematic diagram of a system 10 for an example project that may be associated with a bid request to be facilitated by the bidding proposal system discussed above. That is, the bidding proposal system may receive a request for a bid on a project similar to that provided in the system 10. Referring now to FIG. 1, the system 10 may include surface equipment 12 positioned above a geological formation 14. In the example of FIG. 1, a drilling operation has previously been carried out to drill a wellbore 16. In the illustrated embodiment, cement 18 has been used to seal an annulus 20 (i.e., the space between the wellbore 16 and casing joints 22 and collars 24) with cementing operations. The casing joints 22 represent lengths of conductive pipe, which may be formed from steel or similar materials. In certain embodiments, the casing joints 22 each may include an externally threaded (male thread form) connection at each end. A corresponding internally threaded (female thread form) connection in the casing collars 24 may connect two nearby casing joints 22. Coupled in this way, the casing joints 22 may be assembled to form a casing string 34 to a suitable length and specification for the wellbore 16. The casing joints 22 and/or collars 24 may be made of carbon steel, stainless steel, or other suitable materials to withstand a variety of forces, such as collapse, burst, and tensile failure, as well as chemically aggressive fluid.

The surface equipment 12 may carry out various well logging operations to detect conditions of the wellbore 16. The well logging operations may measure parameters of the geological formation 14 (e.g., resistivity or porosity) and/or the wellbore 16 (e.g., temperature, pressure, fluid type, or fluid flowrate). Some of these measurements may be obtained at various points in the design, drilling, and completion of the well, and may be used in an integrated cement evaluation. Other measurements may be obtained that are specifically used to determining well integrity, and an acoustic logging tool 26 may obtain at least some of these measurements.

The example of FIG. 1 shows the acoustic logging tool 26 being conveyed through the wellbore 16 by a cable 28. Such a cable 28 may be a mechanical cable, an electrical cable, or an electro-optical cable that includes a fiber line protected against the harsh environment of the wellbore 16. In other embodiments, however, the acoustic logging tool 26 may be conveyed using any other suitable conveyance, such as coiled tubing. The acoustic logging tool 26 may obtain measurements of amplitude and variable density from sonic acoustic waves, acoustic impedance from ultrasonic waves, and/or flexural attenuation and velocity from the third interface echo. The availability of these independent measurements may be used to increase accuracy and confidence in the well integrity evaluation and interpretation made possible by the acoustic logging tool 26. The acoustic logging tool 26 may be deployed inside the wellbore 16 by the surface equipment 12, which may include a vehicle 30 and a deploying system such as a drilling rig 32. Data related to the geological formation 14 or the wellbore 16 gathered by the acoustic logging tool 26 may be transmitted to the surface, and/or stored in the acoustic logging tool 26 for later processing and analysis. In certain embodiments, the vehicle 30 may be fitted with or may communicate with a computer and software to perform data collection and analysis.

FIG. 1 also schematically illustrates a magnified view of a portion of the wellbore 16. As mentioned above, the acoustic logging tool 26 may obtain acoustic measurements relating to the presence of solids or liquids behind the casing 22. When the acoustic logging tool 26 provides such measurements to the surface equipment 12 (e.g., through the cable 28), the surface equipment 12 may pass the measurements as data 36 to a data processing system 38 that includes a processor 40, memory 42, storage 44, and/or a display 46. In other examples, the data 36 may be processed by a similar data processing system 38 at any other suitable location (e.g., remote data center). The data processing system 38 may collect the data 36 and determine one or more indices and indicators that, as described in greater detail herein, may objectively indicate the well integrity. Additionally or alternatively, the data processing system 38 may correlate a variety of data obtained throughout the creation of the well (e.g., design, drilling, logging, well completion, etc.) that may assist in the evaluation of the well integrity. Namely, the processor 40, using instructions stored in the memory 42 and/or storage 44, may calculate the indicators and/or indices and/or may collect and correlate the other data into the well integrity evaluation. As such, the memory 42 and/or the storage 44 of the data processing system 38 may be any suitable article of manufacture that can store the instructions. The memory 42 and/or the storage 44 may be ROM, random-access memory (RAM), flash memory, an optical storage medium, or a hard disk drive, to name a few examples. The display 46 may be any suitable electronic display that can display the logs, indices, and/or indicators relating to the well integrity.

FIG. 1 just illustrates one example of the projects with example equipment and services, which may be associated with certain policies, restrictions, or regulations established by a local government, a specific client, or the like. Indeed, depending on the location of the projects, there may be different policies (e.g., Health Safety Environment (HSE) Policy) and restrictions associated with the performance of the project. During the bidding process, information about the policies, restrictions, equipment, tools, materials, and other requirements may be requested from the bidder. To efficiently process and provide bids for various projects, the bidding proposal system may analyze received bid requests and prepare corresponding bidding proposals based on previous bid proposals and their respective datasets related to policies, restrictions, tools, materials, and other requests.

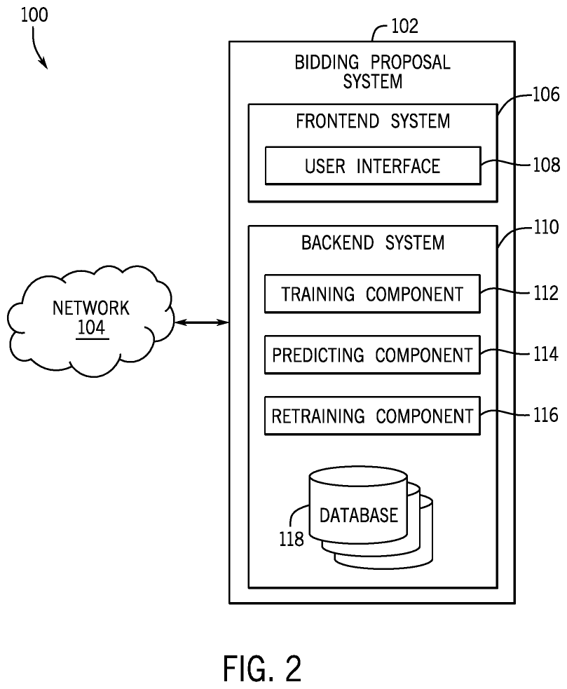

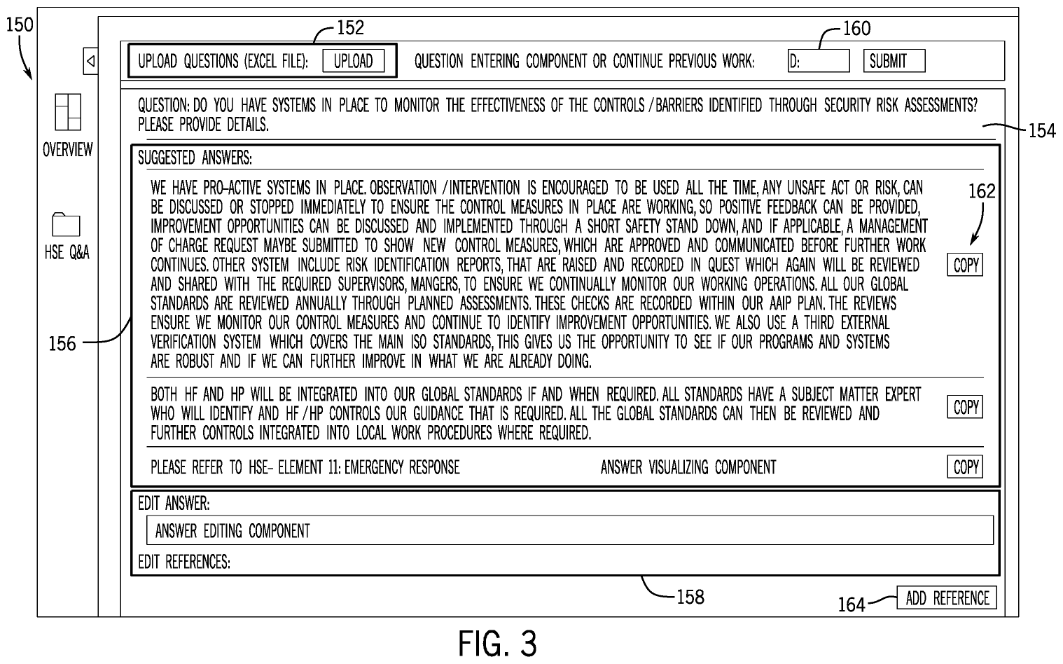

FIG. 2 illustrates an embodiment of a bidding proposal system environment 100. In some embodiments, the bidding proposal system 102 may be accessible to other devices via a network 104. That is, users at various locations of the world may access the bidding proposal system 102 via the network 104 for projects world widely. As mentioned above, the bidding proposal system 102 may include a frontend system 106 having a user interface 108 and a backend system 110. The backend system 110 may include a training component 112, a predicting component 114, a retraining component 116, and a database 118. The database 118 may include a collection of datasets of triplets (Q, A, R) associated with various bid proposals and resulting bids. The triplets may include a question (Q), an answer (A) to the question (Q), and a reference (R) associated with the answer (A). The reference (R) may include manuals (e.g., user manuals, operating instructions), catalogs, policies (e.g., Health Safety Environment (HSE) Policy), regulations, identification information, and any information associated with the corresponding answer (A). The reference (R) may be provided in various data formats, such as CSV files, JSON files, PDF documents, HTML pages, and the like. In some embodiments, the reference (R) may include access information to a website, a database, and any other data sources. For instance, the reference (R) may include a document, part of a document, a text string, a keyword, a number, a URL (uniform resource locator) associated with corresponding resources, and the like. Additional details regarding the frontend system 106 and backend system 110 will be illustrated in detail below with reference to FIGS. 3-6.

FIG. 3 illustrates an example visualization 150 (e.g., graphic user interface (GUI)) of the user interface 108 in the frontend system 106 of the bidding proposal system 102. The visualization 150 may include various components. In the embodiment illustrated in FIG. 3, the visualization 150 includes a question input component 152, a question visualization component 154, a potential answer visualization component 156, and an answer editing component 158. The question input component 152 may enable users to type questions manually or upload questions from a file (e.g., an excel file). Users may also continue a previous bidding proposal by inputting an identification number (ID) associated with the previous bidding proposal at an input component 160. The question visualization component 154 shows the questions input at the question input component 152. The potential answer visualizing component 156 may present a list 162 of relevant answers or references identified by the backend system 110 for each question. Some answer of the list 162 may be related to a reference, and the corresponding part of the reference may be cited in the answer, as illustrated in the potential answer visualization component 156. Users may copy and paste the desired answers from the potential answer visualization component 156 using the corresponding “copy” buttons. In addition, a user drag the desired answers from the potential answer visualization component 156 to the answer editing component 158. Users may edit the answers at the answer editing component 158, and the edited answer may be saved by the backend system 110. Users may add a reference to the answer by using an adding reference component 164.

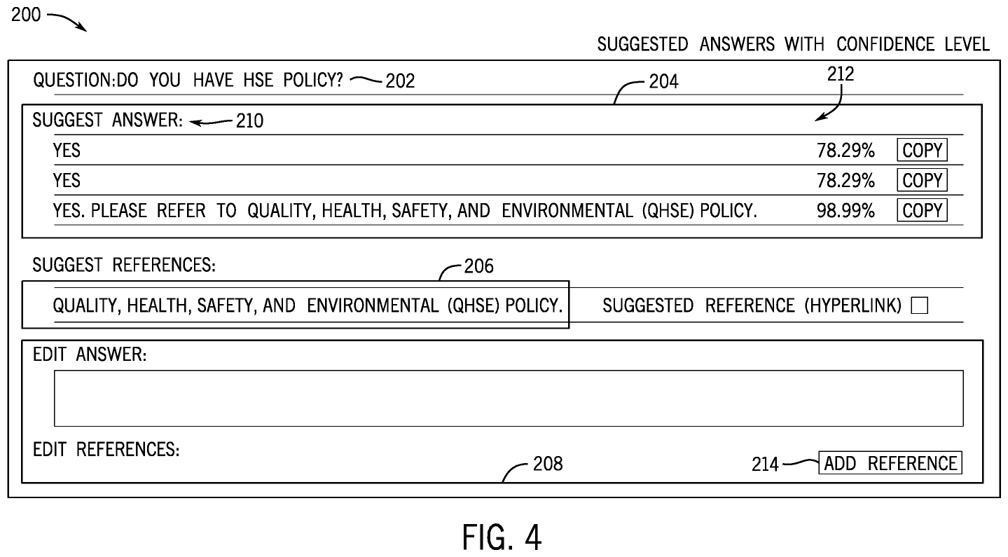

FIG. 4 illustrates another visualization 200 of the user interface 108 in the frontend system 106 of the bidding proposal system 102. In the embodiment illustrated in FIG. 4, the visualization 200 may include a question visualization component 202, an output component 204, a reference visualization component 206, and an answer/reference editing component 208. The output component 204 may include suggested answers 210 with corresponding confidence levels 212. In the embodiment illustrated in FIG. 4, a URL is used in 206 for a reference (e.g., Quality, Health, Safety, and Environmental (QHSE) Policy). In some embodiments, the answers and/or references may be ordered by corresponding relevance levels (e.g., the confidence levels 212) as defined by the backend system 110, as illustrated in FIG. 4. Some answers of the suggested answers 210 may be related to a reference, and the corresponding reference may be cited in the answer, as illustrated in the output component 204. Users may copy and paste the desired answers from the output component 204 using the corresponding “copy” buttons or may drag the desired answers from the output component 204 to the answer/reference editing component 208. Users may edit the answers at the answer/reference editing component 208, and the edited answer may be saved by the backend system 110. Users may add a reference to the answer by using an adding reference component 214. In some embodiments, the answer/reference editing component 208 may enable users to accept or reject the answers and/or references generated by the backend system 110, add additional text to the answers or references, or modify the predicted answers or references. The answer/reference editing component 208 may allow users to download the edited answers in a predefined format (e.g., word file containing the questions, the corresponding answers, the references), such that they may be used for the bidding proposal.

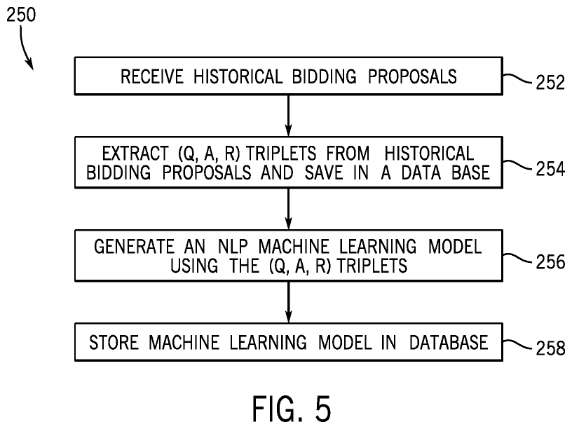

Before presenting the visualization 150 or the visualization 200, the bidding proposal system 102 may collect bid requests and corresponding bid proposals over time to generate a machine learning model to help predict answers for future bid requests. As such, FIG. 5 illustrates a flow diagram of a method 250 for generating a machine learning model in accordance with embodiments herein. Although the method 250 is described as being performed in a particular order and by the bidding proposal system 102, it should be noted that the method 250 may be performed by any suitable computing system and in any suitable order.

With this in mind, at block 252, the bidding proposal system 102 (e.g., via the training component 112) may receive historical bidding proposals. In some embodiments, the bidding proposal system 102 may store the historical bidding proposals in the database 118, which may organize the collected data as a collection of datasets of triplets (Q, A. R) that may correspond to bid requests, bid responses, and the like collected over a period of time. The period of time may provide the bidding proposal system 102 training data used to detect patterns, identify correlations, and detect common features between certain questions, answers, and references. In some embodiments, the training component 112 of the backend system 110 may generate a natural language processing (NLP) machine learning model based on the collected data to evaluate a newly provided dataset of triplets (Q, A, R).

At block 254, the bidding proposal system 102 may extract (Q, A, R) triplets from the historical bidding proposals. In some embodiments, the bidding proposal system 102 may retrieve the historical bidding proposals from the storage components and extract datasets of triplets from the historical bidding proposals. In some embodiments, the bidding proposal system 102 may also collect datasets of triplets that may be entered via the user interface 108 by a user. In any case, each of the datasets of triplets may include a question (Q), an answer (A) to the question (Q), and a reference (R) corresponding to the answer (A).

To generate the natural language processing (NLP) machine learning model, each question (Q) may be identified based on its intent. For example, many questions asked by the users may have a same intent and may thus be associated with the same one question (Q). On the other hand, the same question asked by different users may have different intents under various situations. As such, these similar or identical questions may be represented with different questions (Q).

In addition, each question (Q) may have one or more answers (A). In some embodiments, each question (Q) may be associated with a respective relevance level. As mentioned above, the relevance level may be directly correlated to the confidence level. As illustrated in the output component 204 in FIG. 4, the one or more answers (A) may be provided to the users with corresponding confidence levels, and the users may select one or more answers and corresponding references via the user interface 108. The reference (R) may include a URL (uniform resource locator) or other interactive component (e.g., an interactive link) that may provide access or open applications to view corresponding resources, a document, part of a document, a text string, a keyword, a number, and the like. The users may also select or edit the reference, as illustrated in the output component 208 in FIG. 4.

After extracting the datasets of triplets (Q, A, R), at block 256, the bidding proposal system 102 may generate the NLP machine learning model to predict answers (A) and references (R) for questions (Q). That is, the bidding proposal system 102 may build a text embedding space with the triplets (Q, A, R) and identify one or more patterns between questions (Q) and answers (A) of the extracted datasets of triplets. In the text embedding space, the relationships between each element of the triplets may be represented with valued vectors that correspond to the relationship or strength of relationship between each element. For example, the more closely related that two triplets (Q, A, R) are, the smaller distance between the two triplets (Q, A, R) in the text embedding space. For a same question (Q), the one or more answers (A) may have different relevance levels corresponding to different distances. Within the text embedding space, the answers (A) with smaller distances between the respective question (Q) corresponds to answers (A) with higher relevance levels.

Using the relationships between the triplets (Q, A, R), components of the triplets, and other features represented in the text embedding space, the bidding proposal system 102 may generate the NLP machine learning model that may receive a question (Q) input and output the closest identified answer (A) and reference (R) as indicated it the text embedded space. In some embodiments, the mappings provided in the text embedding space may be stored in a spreadsheet, a list, or some other suitable medium that may be efficiently parsed. For example, the relationships between the datasets of triplets may be stored in a look-up table (LUT), such that the bidding proposal system 102 may query the LUT using a question (Q) to efficiently determine the most closely related answer (A), reference (R), or both.

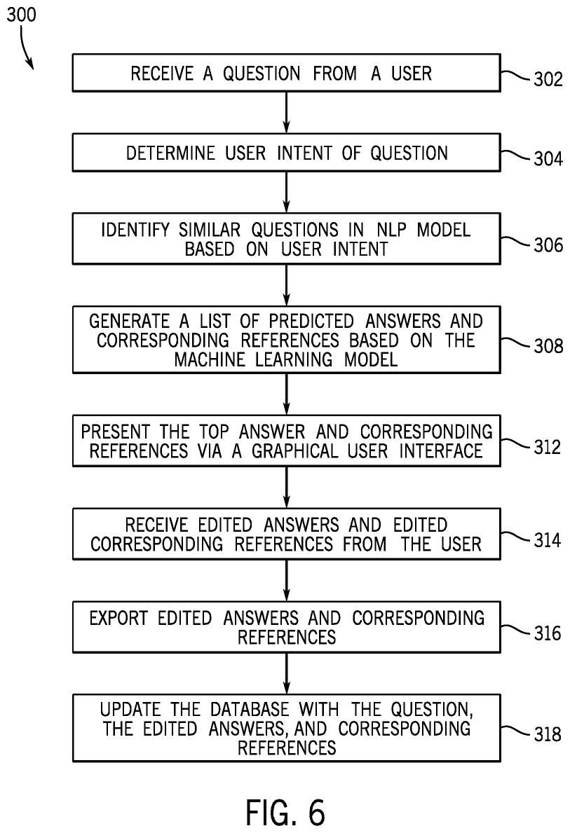

At block 258, the bidding proposal system 102 may store the NLP machine learning model and the triplets (Q, A, R) in the database 118. After the machine learning model is generated, the backend system 110 may use the machine learning model to predict answers corresponding to user inputs, as illustrated in FIG. 6.

FIG. 6 illustrates a flow chart of a method 300 for predicting answers based on the NLP machine learning model determined above. Although the method 300 is described as being performed in a particular order and by the backend system 110, it should be noted that the method 300 may be performed by any suitable computing system and in any suitable order.

At block 302, the backend system 110 may receive a question from a user. The question may correspond to a question provided in a bid request and may be related to a question provided in a historical bid request. After receiving the question, the backend system 110 may prepare or modify a format of the question (e.g., the backend system 110 may translate the question using a default language), such that the question may be properly analyzed by the NLP machine learning algorithm. For example, at block 304, the backend system 110 may determine an intent of the question based on similar types of questions represented in the NLP machine learning model. That is, the backend system 110 may analyze the question using the NLP machine learning model to determine the user intent of the question.

At block 306, the backend system 110 may query the NLP machine learning model for relevant (Q, A, R) triplets that correspond to the intent of the received question. That is, the backend system 110 may parse the text embedding space represented by the NLP machine learning model by comparing the received question (Q) with the questions in the text embedding space.

At block 308, the backend system 110 may employ the predicting component 114 to query the trained NLP machine learning model based on the received question and automatically provide a list of predicted relevant answers (A) and corresponding references (R) that closely match the received question. In some embodiments, the distance in the text embedding space between each (Q, A, R) triplet and the received question may be calculated and the list of predicted relevant answers may be ranked based on corresponding relevance levels (e.g., confidence levels).

At block 312, the backend system 110 may present a number of answers (e.g., top three ranked answers, subset of all answers, all answers) together with the corresponding references via the frontend system 106 (e.g., the user interface 108) as predicted answers. For instance, the frontend system 106 may present the list of answers via the potential answer visualization component 156 of the visualization 150 depicted in FIG. 3.

At block 314, the backend system 110 may receive edited answers and references from the user, as explained above with reference to FIG. 3 and FIG. 4. At block 316, the backend system 110 may export the edited answers and corresponding references such that they may be used for the bidding proposal for the user. That is, the backend system 110 may insert the edited answers and references (or unedited selected answers) to the relevant fields of the bid proposal. In some embodiments, the bid proposal may be provided via an electronic document. As such, the backend system 110 may propagate the relevant fields with the answers. In other embodiments, the bid proposal may be provided via a digital interface, such as a website or portal. In this case, the backend system 110 may access the digital interface, query the questions, and insert the selected answer. In addition, the backend system 110 may allow the user to copy the selected or edited answer to paste into an appropriate field.

At block 318, the backend system 110 may update the database 118 with the question, the edited answers and corresponding references. After the database 118 or other suitable storage component is updated, the bidding proposal system 102 may generate new (Q, A, R) triplets based on the corresponding bidding proposals and update the NLP machine learning model in accordance with embodiments described above. The new (Q, A, R) triplets may be used to retrain the NLP machine learning model by using the retraining component 116. By retraining the machine learning model, the bidding proposal system 102 may provide more accurate predictions for future questions.

It should be noted that by using the updated answers and newly generated answers to retrain the NLP machine learning model, the present embodiments enable any computing device performing the methodologies described herein to perform these operations more efficient (e.g., using fewer computing resources, less time). As such, the present embodiments may allow systems that predict bidding process answers to operate more efficiently using less computing processing power.

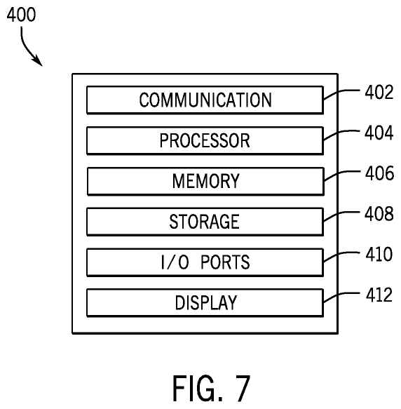

FIG. 7 illustrates an example computing device 400 suitable for implementing the bidding proposal system 102. The computing device 400 may include various types of components that may perform various types of computer tasks and operations. For example, the computing device 400 may include communication component 402, a processor 404, a memory 406, a storage 408, input/output (I/O) ports 410, a display 412, and the like.

The communication component 402 may be a wireless or wired communication component that may facilitate communication between the computing device 400 and various other devices via a network, the internet, or the like. The communication component 402 may use a variety of communication protocols, such as Open Database Connectivity (ODBC), TCP/IP Protocol, Distributed Relational Database Architecture (DRDA) protocol, Database Change Protocol (DCP), HTTP protocol, other suitable current or future protocols, or combinations thereof.

The processor 404 may process instructions for execution within the computing device 400. The processor 404 may include single-threaded processor(s), multi-threaded processor(s), or both. The processor 404 may process instructions stored in the memory 406. The processor 404 may also include hardware-based processor(s) each including one or more cores. The processor 404 may include general purpose processor(s), special purpose processor(s), or both. The processor 404 may be communicatively coupled to other internal components (such as the communication component 402, the storage 408, the I/O ports 410, and the display 412).

The memory 406 and the storage 408 may be any suitable articles of manufacture that can serve as media to store processor-executable code, data, or the like. These articles of manufacture may represent computer-readable media (e.g., any suitable form of memory or storage) that may store the processor-executable code used by the processor 404 to perform the presently disclosed techniques. As used herein, applications may include any suitable computer software or program that may be installed onto the computing device 400 and executed by the processor 404. The memory 406 and the storage 408 may represent non-transitory computer-readable media (e.g., any suitable form of memory or storage) that may store the processor-executable code used by the processor 404 to perform various techniques described herein. It should be noted that non-transitory merely indicates that the media is tangible and not a signal.

The I/O ports 410 may be interfaces that may couple to other peripheral components such as input devices (e.g., keyboard, mouse), sensors, input/output (I/O) modules, and the like. The display 412 may operate as a human machine interface (HMI) to depict visualizations associated with software or executable code being processed by the processor 404. In one embodiment, the display 412 may be a touch display capable of receiving inputs from an operator of the computing device 400. The display 412 may be any suitable type of display, such as a liquid crystal display (LCD), plasma display, or an organic light emitting diode (OLED) display, for example. Additionally, in one embodiment, the display 412 may be provided in conjunction with a touch-sensitive mechanism (e.g., a touch screen) that may function as part of a control interface for the computing device 400.

It should be noted that the components described above with regard to the computing device 400 are examples and the computing device 400 may include additional or fewer components relative to the illustrated embodiment.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

What is claimed is:

1. A method, comprising:
receiving, via a processing system, an input indicative of a question associated with a bid proposal request;
determining, via the processing system, an intent associated with the question;
determining, via the processing system, one or more answers associated with the question based on a machine learning model and the intent, wherein the machine learning model is generated based on a plurality of datasets associated with one or more correlations between a plurality of questions and a plurality of answers, wherein each of the plurality of datasets comprises a triplet of data including a respective question, a respective answer, and a respective reference;
presenting, via the processing system, the one or more answers via a visualization component depicted in an electronic display communicatively coupled to the processing system;
receiving, via the processing system, one or more modifications to the one or more answers via the visualization component to generate one or more modified answers; and
exporting, via the processing system, the one or more modified answers to one or more fields of the bidding proposal request.

2. The method of claim 1, wherein the one or more correlations corresponds to a text embedded space.

3. The method of claim 2, wherein the text embedding space comprises a first dataset having a first question, a first answer, and a second answer, wherein the first answer is positioned in the text embedding space closer to the first question as compared to the second answer based on the first answer being associated with a higher relevance level with respect to the first question as compared to the second answer.

4. The method of claim 2, comprising generating a list of answers for the question by ranking a plurality answers positioned in the text embedded space based on respective relevance levels of the plurality answers with respect to the question.

5. The method of claim 4, comprising presenting the list of answers via the visualization component depicted in the electronic display with the respective relevance levels.

6. The method of claim 5, comprising presenting three answers of the list of answers via the visualization component depicted in the electronic display with three respective relevance levels.

7. The method of claim 1, comprising retraining the machine learning model based on the one or more modified answers and the question.

8. The method of claim 1, wherein the machine learning model comprises a natural language machine learning model.

9. The method of claim 1, wherein the respective reference of the triplet of data of each of the plurality of datasets comprises an interactive link configured to cause the processing system to access information associated with the respective answer.

10. A system, comprising:
one or more processors; and
memory, accessible by the one or more processors, and storing instructions that, when executed by the one or more processors, cause the one or more processors to perform operations comprising:
receiving an input indicative of a question associated with a bid proposal request;
determining an intent associated with the question;
determining one or more answers associated the question based on a machine learning model and the intent, wherein the machine learning model is generated based on a plurality of datasets associated with one or more correlations between a plurality of questions and a plurality of answers, wherein each of the plurality of datasets comprises a triplet of data including a respective question, a respective answer, and a respective reference;
presenting the one or more answers via a visualization component depicted in an electronic display;
receiving one or more modifications to the one or more answers via the visualization component to generate one or more modified answers; and
exporting the one or more modified answers to one or more fields of the bidding proposal request.

11. The system of claim 10, wherein the one or more correlations corresponds to a text embedded space.

12. The system of claim 11, wherein the text embedding space comprises a first dataset having a first question, a first answer, and a second answer, wherein the first answer is positioned in the text embedding space closer to the first question as compared to the second answer based on the first answer being associated with a higher relevance level with respect to the first question as compared to the second answer.

13. The system of claim 11, wherein a list of answers for the question is generated by ranking a plurality answers positioned in the text embedded space based on respective relevance levels of the plurality answers with respect to the question.

14. The system of claim 10, wherein the machine learning model is retrained based on the one or more modified answers and the question.

15. The system of claim 10, wherein the machine learning model comprises a natural language machine learning model.

16. The system of claim 10, wherein the respective reference of the triplet of data of each of the plurality of datasets comprises an interactive link to access information associated with the respective answer.

17. A non-transitory, computer readable medium comprising instructions that, when executed by one or more processors, cause the one or more processors to perform operations comprising:
receiving an input indicative of a question associated with a bid proposal request;
determining an intent associated with the question;
determining one or more answers associated the question based on a machine learning model and the intent, wherein the machine learning model is generated based on a plurality of datasets associated with one or more correlations between a plurality of questions and a plurality of answers, wherein each of the plurality of datasets comprises a triplet of data including a respective question, a respective answer, and a respective reference;
presenting the one or more answers via a visualization component depicted in an electronic display;
receiving one or more modifications to the one or more answers via the visualization component to generate one or more modified answers; and
exporting the one or more modified answers to one or more fields of the bidding proposal request.

18. The non-transitory, computer readable medium of claim 17, wherein the one or more correlations corresponds to a text embedded space.

19. The non-transitory, computer readable medium of claim 18, wherein the text embedding space comprises a first dataset having a first question, a first answer, and a second answer, wherein the first answer is positioned in the text embedding space closer to the first question as compared to the second answer based on the first answer being associated with a higher relevance level with respect to the first question as compared to the second answer.

20. The non-transitory, computer readable medium of claim 17, wherein the respective reference of the triplet of data of each of the plurality of datasets comprises an interactive link to access information associated with the respective answer.
